(19) United States
(12) Patent Application Publication
(10) Pub. No.: US 2006/0191953 A1
(43) Pub. Date: Aug. 31, 2006

(54) Device for introducing pharmaceutical products into blister packs

(76) Inventors: Daniel Hiddink, Zug (CH); Andreas Gabriel, Muserhof (CH); Urs Barmettler, Brunnen (CH)

Correspondence Address: COHEN, PONTANI, LIEBERMAN & PAVANE, 551 FIFTH AVENUE, SUITE 1210, NEW YORK, NY, 10176, US

(21) Appl. No.: 10/552,286

(22) PCT Filed: Mar. 26, 2004
(86) PCT No.: PCT/CH04/00185

§ 371 Date: Oct. 4, 2005

(30) Foreign Application Priority Data
Apr. 8, 2003 (CH) 631 03

(51) Int. Cl. G07F 11/16

(52) U.S. Cl. 221/289

(57) ABSTRACT

A device for introducing a plurality of solid pharmaceutical products selected from the group consisting of tablets, two-part capsules, sugar-coated pills, gelatin capsules, and oblongs along a path into blister packs includes a distributing device having a roll frame, and at least one pair of first and second rolls mounted on the roll frame and rotatable in opposite directions, the first and second rolls having respective non-cylindrical sections facing one another and spaced apart so as to define a gap configured to provide a passage for each individual pharmaceutical product, wherein the first and second rolls rotate in opposite directions.

The invention pertains to a device of the type indicated in the introductory clause of claim 1 for introducing solid pharmaceutical products into blister packs.

Devices of this type are used when solid pharmaceutical products such as tablets, capsules, sugar-coated pills, and the like are to be loaded into blister packs. The basic goal is to supply exactly one product to each well of the blister pack.

A device of the type indicated in the introductory clause of claim 1 is known from DE 100 26 496 A1. From a supply container, in which the products are present as bulk material in completely random order, the products are gravity-fed to the individual wells of the blister pack by means of an isolating block.

A similar device for accomplishing the same task is known from U.S. Pat. No. 5,737,902 A.

A device for orienting asymmetric objects is known from FR 1,420,280 A. This device has a pair of counterrotating cylindrical rolls.

WO 99/24333 A1 describes a device for isolating agricultural products, by means of which the individual objects can be counted and weighed.

A device with which tablets can be packed in tubes is known from U.S. Pat. No. 4,930,289 A. The tubes can be sealed by counterrotating rolls.

A device with which tablets can be loaded into bottles is known from U.S. Pat. No. 2,829,476 A.

The products to be packaged come in many different forms. Tablets are often round and have a cylindrical center section, whereas the two end surfaces have a greater or lesser degree of convex curvature. They are also usually pressed from a preliminary product in the form of powder, which leads to the fact that the surface has a certain roughness. A groove can also be pressed into one of the end surfaces to make it easier to break the tablet in two. Products in the form of capsules and sugar-coated pills are also known.

In devices according to the state of the art, there is the problem that two or more such products can come in contact with each other at the entrance to the isolating block in such a way as to prevent the products from entering the channels of the isolating block. The products start to back up, and the device no longer operates correctly, because it can no longer fill all of the wells of the blister pack with a product. This leads to rejects and to production stoppages.

The invention is based on the task of reliably preventing the formation of such backups and thus of ensuring interruption-free production, in the course of which each well of the blister pack is supplied with one product.

The task indicated above is accomplished according to the invention by the features of claim 1. Advantageous elaborations of the invention can be derived from the dependent claims.

Exemplary embodiments of the invention are explained in greater detail below on the basis of the drawing:

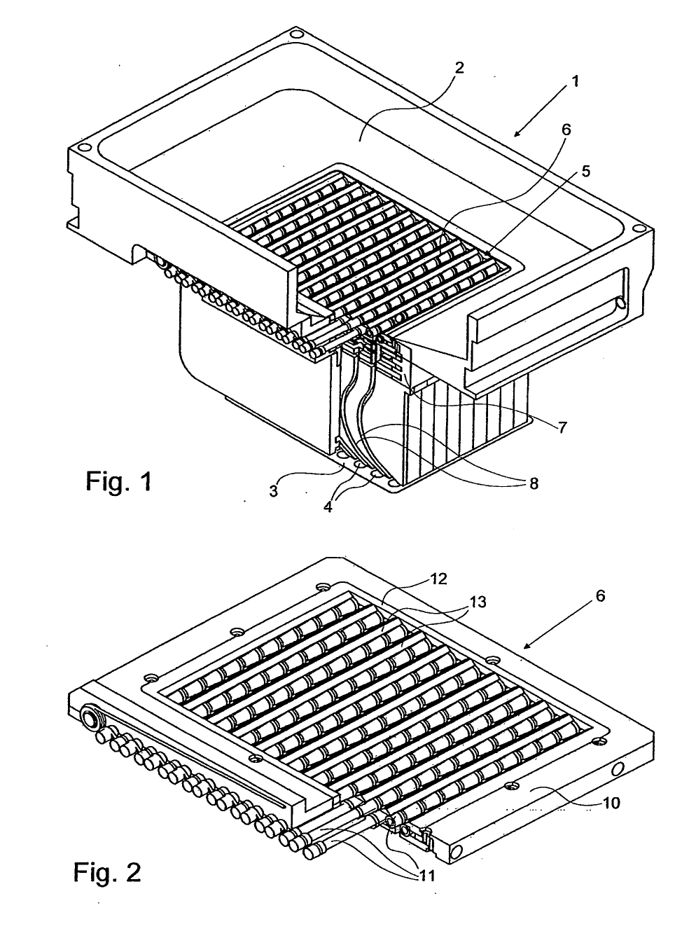

FIG. 1 shows an overall view of the device in partial cross section;

FIG. 2 shows an overall view of a distributing device;

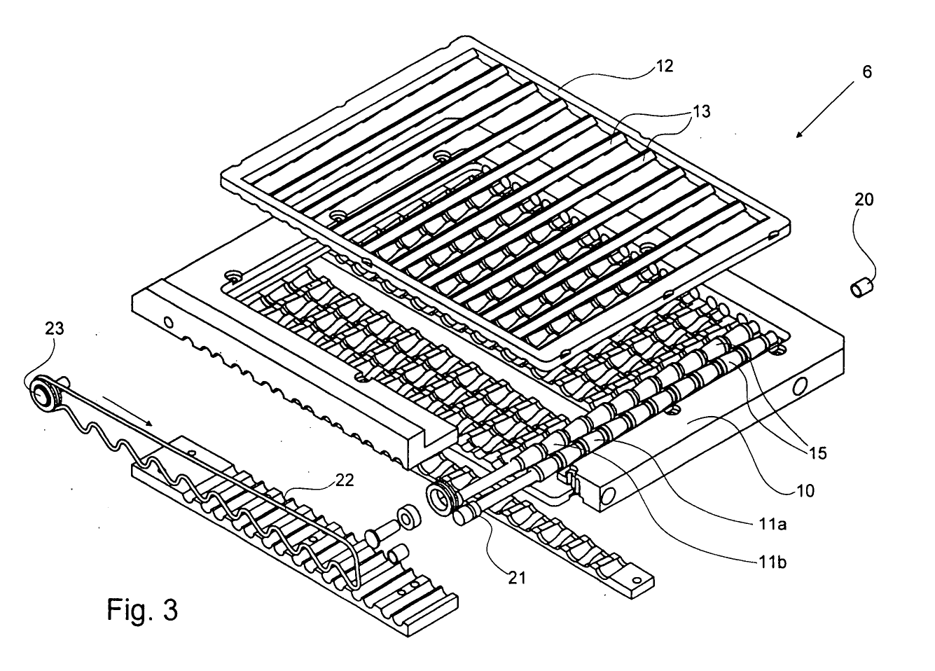

FIG. 3 shows an exploded view of the distributing device;

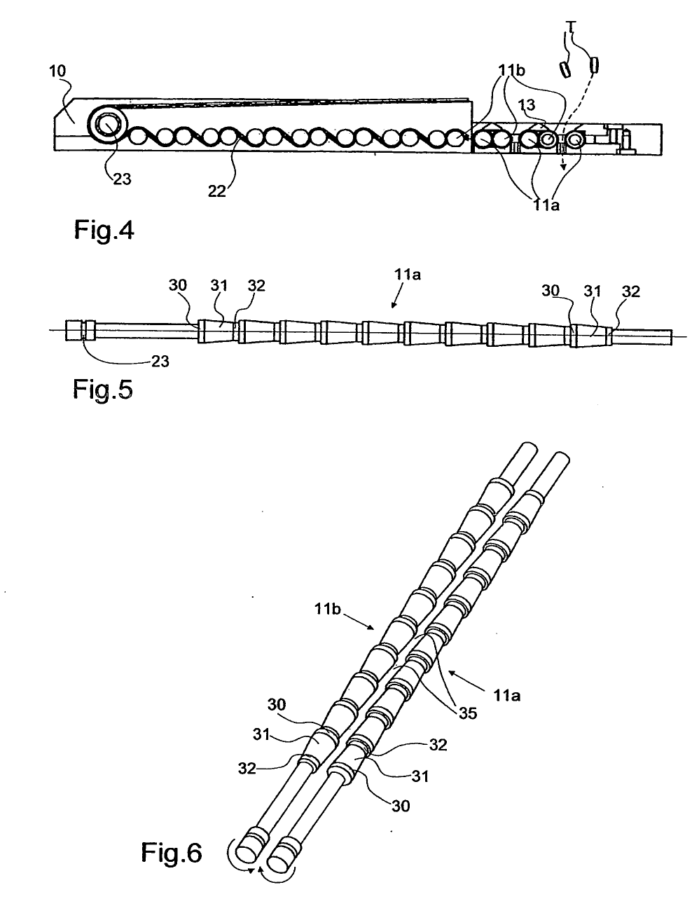

FIG. 4 shows a side view of a roll frame with driven rolls;

FIG. 5 shows a view of a roll;

FIG. 6 shows a perspective view of two rolls;

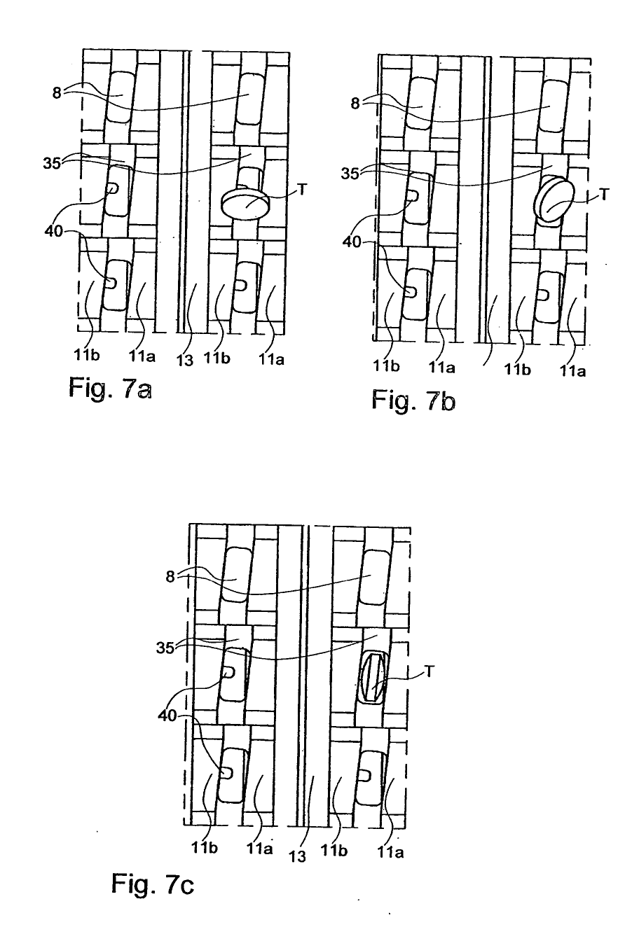

FIGS. 7a-7c show partial plan views of the rolls of the distributing device with a tablet located above the rolls;

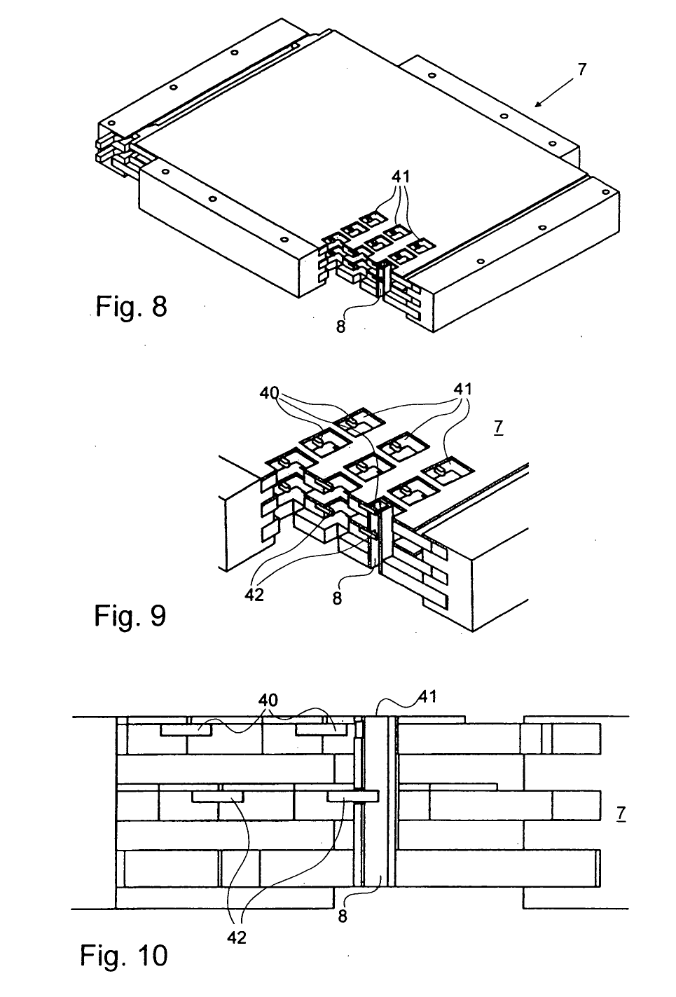

FIG. 8 shows a view of an isolating block;

FIG. 9 shows a detail of the block;

FIG. 10 shows a cross-sectional view of the block;

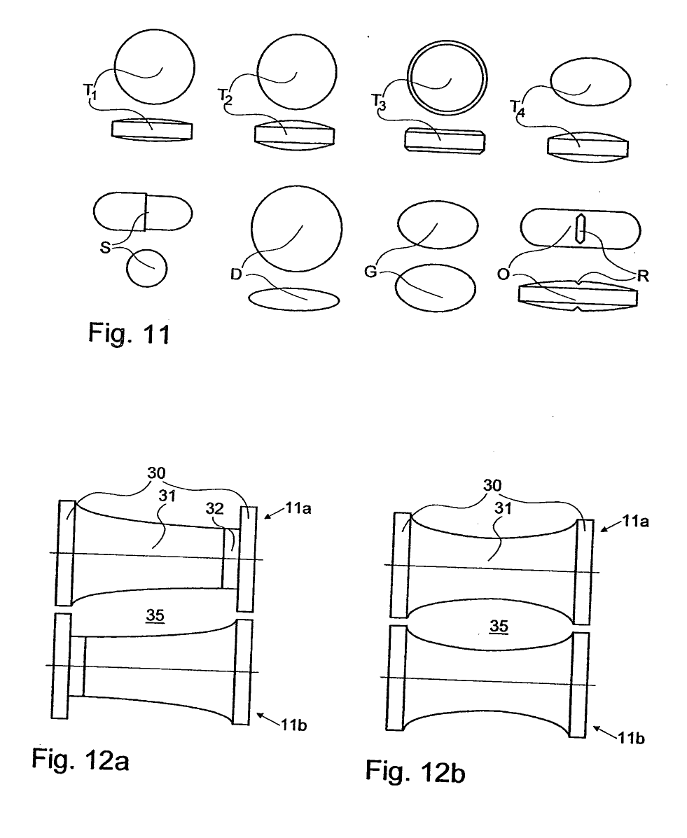

FIG. 11 shows various forms of solid pharmaceutical products;

FIGS. 12a-12b show design variants of the rolls; and

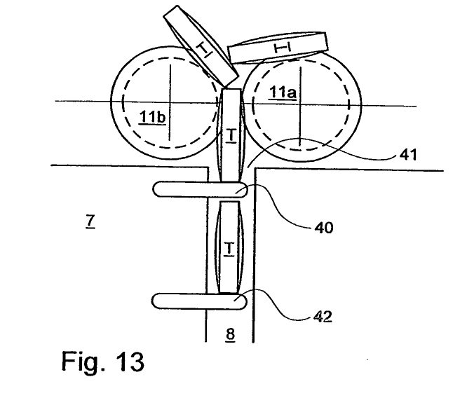

FIG. 13 shows a diagram of the placement of the rolls above the isolating block.

In FIG. 1, 1 designates a device for introducing solid pharmaceutical products into blister packs. The uppermost part of the device 1 consists of a pan 2, in which the products such as tablets, capsules, sugar-coated pills, and the like to be loaded into to the blister packs are present as bulk material. Underneath the device 1 is one of these blister packs 3 with individual wells 4, each of which holds one object. The bottom surface of the pan 2 has an opening 5, which is closed off by a horizontal distributing device 6. The design of the distributing device 6 will be described in detail further below. Under the distributing device 6 is an isolating block 7, which corresponds to the state of the art. Between the isolating block 7 and the blister pack 3, the objects to be packaged pass through isolating channels 8, one such isolating channel 8 being assigned to each well 4 of the blister pack 3.

FIG. 2 shows an overall view of the previously mentioned distributing device 6 in one of its inventive embodiments. In a roll frame 10, rolls 11 are supported with the freedom to rotate. As will be discussed again later, there are two different types of rolls 11, which alternate with, and are parallel to, each other. Above the rolls 11, a cover frame 12 is provided, which has individual webs 13 with a more-or-less triangular cross section.

FIG. 3 shows the same distributing device 6 in the form of an exploded diagram. At the top is the cover frame 12 with its webs 13. Underneath is the roll frame 10, in which two types of rolls 11, namely, first rolls 11a and second rolls 11b, are arranged, always alternating with each other. One roll 11a forms a pair with the roll 11b located to its left. In this first exemplary embodiment, each of the rolls 11a, 11b has conical sections 15.

With respect to the spatial arrangement of the conical sections 15, there is a difference between the rolls 11a and the rolls 11b, namely, the angle of the conical sections 15 of the rolls 11a is exactly the opposite of the angle of the conical sections of the rolls 11b. This will be shown in greater detail later on. Thus the essential feature of the inventive design according to this exemplary embodiment is already presented. The other details of FIG. 3 show advantageous designs. This pertains, for example, to the bushings 20, which are installed in the roll frame 10, and in which the rolls 11a, 11b are rotatably supported. For the sake of clarity, only one of these bushings 20 is shown.

It is significant with respect to the invention, however, that the rolls 11, that is, the rolls 11a and 11b, project at one end from the roll frame 10, which could already be seen in FIG. 2. The reason for this measure is that the rolls 11a, 11b must be driven, and according to the invention the direction in which the rolls 11a rotate is opposite that in which the rolls 11b rotate. This will also be shown and described in more detail further below. It is advantageous for each roll 11a, 11b to have on this projecting end an annular groove 21, in which a belt 22 engages, which wraps part way around each of the rolls 11a, 11b. The belt 22 also runs around a belt tensioner 23. In this way, all the rolls 11a, 11b are connected to each other in a nonpositive manner. When the belt 22 is driven in one direction, as indicated by an arrow in FIG. 3, all the rolls 11a rotate in one direction and all the rolls 11b rotate in the opposite direction. The motorized drive itself can take various forms, any of which can be selected on the basis of the expert's experience and knowledge. For example, the belt tensioner 23 can be driven by a motor (not shown), or one of the rolls 11a or 11b can be driven. Because of the nonpositive connection produced by the belt 22, it is ensured that all the rolls 11a, 11b will rotate.

This design can also be seen in FIG. 4, which shows a side view of the roll frame 10 with the driven rolls 11a, 11b, where, in analogy to FIGS. 1-3, a partial cross section appears on the right. Visible here again are the rolls 11a and 11b in the roll frame 10, the belt 22, and the belt tensioner 23. The triangular cross section of the webs 13 of the cover frame 12 can also be seen here.

Also appearing in the figure are two tablets T and the route, indicated in the broken line, to be taken by one of them between two adjacent rolls 11a and 11b in the direction toward the isolating channel 8 (FIG. 1), not shown here. These isolating channels 8 begin underneath the gap between the adjacent rolls 11a, 11b.

FIG. 5 shows a side view of a roll 11. The example shows a roll 11a. At one end, as already indicated in FIG. 3, it has an annular groove 21, in which the belt 22 (FIGS. 3 and 4) engages. According to the invention, the roll 11a has noncylindrical sections. The design of the noncylindrical sections is closely related to the shape of the pharmaceutical product to be packaged.

A first exemplary embodiment, which will be used when the products to be packaged are tablets T, is explained in greater detail below (FIG. 4). In this case, it is advantageous for the rolls 11a to have a periodic sequence of three special sections, in which a first cylindrical section 30 with a certain larger diameter D₁ is followed by a noncylindrical section 31, which is followed in turn by a second cylindrical section 32 with a certain smaller diameter D₂. The noncylindrical section 31 has the shape of a truncated cone. The sequence of sections 30, 31, 32 repeats several times over the length of the roll 11a. The truncated cone-shaped section 31 has the larger diameter D₁ on the end facing the first cylindrical section 30 and the smaller diameter D₂ at the end facing the second cylindrical section 32.

The dimensions of the sections 30, 31, 32 are related to the shape and size of the tablets T to be isolated by the device (FIG. 4). Thus, for example, the overall length of a periodic sequence of the sections 30, 31, 32 is approximately 14 mm, where each of the sections 30 and 32 is 2 mm long, and the truncated cone-shaped section 31 accounts for the remaining length of approximately 10 mm. The ratio of the diameters D₁, D₂ is calculated more-or-less so that the conical surface has an angle of approximately 5° to the axis of the roll 11a. The previously mentioned dimensions are to be understood as examples for a certain shape and size of tablet. Depending on the shape and size of the tablets T, these dimensions can vary in practice to a greater or lesser degree.

FIG. 6 shows a perspective view of two adjacent rolls, namely, a first roll 11a on the right and a second roll 11b on the left. This thus represents another illustration of the rolls 11a and 11b already shown in FIG. 3. What is essential to the invention, however, is that the sequence of the sections 30, 31, 32 and the rotational direction, indicated by arrows in FIG. 6, of the rolls 11a are opposite the sequence and the direction of the rolls 11b. Between the two rolls 11a and 11b there is a gap 35, through which the tablets T (FIG. 4) can pass. The gap 35 is therefore larger by a certain amount than the thickness of the tablets 4. If, as in this exemplary embodiment, the noncylindrical sections 31 are in the form of truncated cones, the gap 35 will have a constant width.

If we now consider FIG. 6 together with FIG. 4, we see that the tablets T can pass only through the gap 35 between the roll 11a on the right and the roll 11b on the left. It can be seen in FIG. 4 that the tablets T cannot pass through between a roll 11b on the right and a roll 11a adjacent on the left, first, because these two rolls 11a, 11b are so close together that the tablets T cannot pass between them, and, second, because a web 13 is positioned above them. Because this web has a triangular cross section with one vertex pointing upward and the other two vertices being on the same level at the bottom, each web 13 has a slanted surface on each side, along which the tablets T slide in such a way that the only the route which they can take is that between a roll 11a on the right and a roll 11b on the left. The route between a roll 11b on the right and an adjacent roll 11a on the left is blocked by the web 13.

The difference in the rotational directions of the rolls 11a and 11b is extremely important for the accomplishment of the inventive task. Because the rolls 11a rotate clockwise and the rolls 11b rotate counterclockwise, as seen from the ends of the rolls, the lateral surfaces of the sections 30, 31, 32, seen from the gap 35, move upward. When there is contact between a point on a tablet T with one of the lateral surfaces of the sections 30, 31, 32, therefore, a force is exerted on the tablet T which is opposite the effect which gravity is exerting on the tablet. As a result, it is impossible for a tablet T which is occupying a slanted position between the rotating rolls 11a, 11b to be pulled into the gap, where it could become jammed in place or damaged.

If two tablets T were to be situated next to each other above the gap 35, they would be carried upward by the lateral surfaces of one of the sections 30, 31, 32. Because the tablets T are in completely random order as bulk material in the space above the gap 35, the two tablets T are in contact with other tablets T. It can thus be assumed that the forces acting on one of the individual tablets T will be different than the forces acting on the other one, a fact which always leads to the result that the backup caused by two adjacent tablets T will be quickly cleared away. Experiments have confirmed this.

Whenever a tablet T occupies a position in space such that the tablet T can easily drop through the gap 35, the tablet T will pass through gap 35.

Because the tablets T are in completely random order as bulk material in the pan 2 and because each one can assume any position in space, the tablets T must be rotated in such a way that they can fall through the gap 35 by the force of gravity. This is already done to a certain extent by the interactions among the individual tablets T.

On the basis of the following FIGS. 7a-7c, it is now shown that the tablets T are rotated completely automatically by the noncylindrical sections 31, here in the form of truncated cones, of the two rolls 11a, 11b in such a way that they can fall through the gap 35. FIGS. 7a-7c show top views of the web 13, which is in the center. To the left and right are parts of the rolls 11a, 11b, and the gap 35, which is present between the rolls 11a, 11b. The isolating channels 8 already shown in FIG. 1 can also be seen in these plan views. An upper blocking slide 40 can be seen in some of these isolating channels 8. These slides are provided in all of the isolating channels 8. The upper blocking slides 40 belong to the isolating block 7 (FIG. 1). This will be discussed again in conjunction with the following FIGS. 8, 9, and 10.

FIG. 7a shows the least favorable case in which a tablet T is positioned transversely to the gap 35 and to the axes of the rolls 11a, 11b. For the sake of clarity, only a single tablet T is shown, so that the action of the rotating rolls 11a, 11b can be explained more clearly. When we consider the position of the tablet T, we see that it rests on the rolls 11a, 11b at a minimum of two points. At the contact points, the roll 11b on the left of the tablet T has a larger diameter than the roll 11a on the right of the tablet T. The rolls 11a and 11b rotate in different directions, as can be seen in FIG. 6. It has been found that, as a result of this rotation of the rolls 11a, 11b, a force is exerted on the tablet T which causes the tablet T to rotate.

FIG. 7b shows the next position of the tablet produced by this rotation of the tablet T. The rotation continues and finally leads to the position of the tablet T shown in FIG. 7c. It has thus arrived in a position in which it can drop under the effect of gravity between the rolls 11a and 11b and into the isolating channel 8 underneath until it rests on the upper blocking slide 40 belonging to the isolating channel 8.

What has been shown here on the basis of a single tablet T takes place more-or-less simultaneously at all the similar locations of all the rolls 11a, 11b. Tablets T are thus supplied in this way to all of the isolating channels 8.

FIGS. 8, 9, and 10 show the isolating block 7 already familiar from FIG. 1. This block is largely the same as that according to the known state of the art, but it is described briefly here for the sake of completeness.

FIG. 8 shows a partial cross section through the isolating block 7. Entrance openings 41 of the previously mentioned isolating channels 8 (FIGS. 1, 7a-c) are found on the top surface of the isolating block. Only nine of these entrance openings 41 are shown. The entrance openings 41 are arranged in rows, each row having as many entrance openings as there are truncated cone-shaped sections 31 on the rolls 11a, 11b (FIG. 5). There would therefore be ten of them, as can be seen in FIGS. 5 and 6. The number of rows of entrance openings 41 corresponds to the number of pairs of rolls 11a, 11b, which would therefore also be 10, for example, as can be seen in FIG. 2. Thus there are a total of one hundred entrance openings 41 and correspondingly a total of one hundred isolating channels 8, so that tablets T can be supplied simultaneously to one hundred wells 4 (FIG. 1) of a blister pack 3.

It should be emphasized here, however, that the invention is not limited to this matrix-like arrangement. The principle of the invention, namely, that two differently designed rolls 11a, 11b with noncylindrical sections 31 rotate in opposite directions, can also be applied in the form that only a single pair of rolls 11a, 11b is used. In this case, only one row of wells 4 (FIG. 1) of a blister pack will be filled with product during each work cycle. In the case of the matrix-like arrangement shown with a plurality of rolls 11a, 11b, it is possible to fill all the wells 4 of a blister pack 3 simultaneously, which obviously results in a significant increase in production output. This is a significant advantage.

FIG. 9 shows a magnified view of part of the isolating block 7 according to FIG. 8. Here it can be seen that the upper blocking slide 40 already known from FIGS. 7a-7c is located underneath the entrance opening 41. One of these upper blocking slides 40 is present in each of the isolating channels 8. In addition, a lower blocking slide 42 is positioned in each of the isolating channels 8 underneath the upper blocking slide 40. The free distance between the upper blocking slides 40 and the lower blocking slides 42 is slightly larger than the diameter of the tablets T (FIGS. 7a-7c).

FIG. 10 shows a cross-sectional side view of the isolating block 7 according to FIG. 9. Upper blocking slides 40 and lower blocking slides 42 are shown, which are assigned to each of the isolating channels 8. The upper blocking slides 40 are shown in their retracted position. In this position, a tablet T (FIGS. 7a-7d) entering one of the isolating channels 8 through the entrance opening 41 can fall through to the lower blocking slide 42. The lower blocking slides 42 are located here in the extended position, which makes it impossible for the tablets T to go any farther.

Then the upper blocking slides 40 are moved into the extended position in the known manner, so that no tablets T can come from behind from the distributing device 6. Then the lower blocking slide 42 is moved into the retracted position. As a result, the tablet T can fall through the following section of the isolating channel 8, as can be seen in FIG. 1, and drop into the well 4 of the blister pack 3.

In the exemplary embodiment shown, ten rows of ten isolating channels 8 are present. Thus, blister packs with one hundred wells 4 can be filled with tablets T, where all hundred wells 4 are filled simultaneously. The number of rows and the number of isolating channels 8 in the individual rows depend on how many wells 4 there are in the blister pack 3. It is therefore possible to fill a blister pack 3 completely in a single step. As a result, a very high packaging rate is achieved.

It is important that the tablets should not become jammed up in the distributing device 6 (FIG. 2), because this would prevent a tablet T from entering an isolating channel 8 during a work cycle. If that were to happen, a tablet T would be missing from the blister pack 3, which would mean in turn that the product would have to be rejected. As a result of the invention, the goal is now achieved that such jams cannot occur, with the result that uniform production output is achieved without rejects. In addition, a very high cycle rate can be reached in the filling of blister packs 3. The cycle rates which can be achieved through the invention are much higher that those possible according to the state of the art.

The inventive device is especially advantageous when tablets T with a groove for breaking are to be packaged. These grooves increase the number of jams which occur in the conventional devices.

The increase in the cycle rate, the avoidance of jams, and the avoidance of the production stoppages caused by jams lead to more economical operation.

A first exemplary embodiment suitable for the filling of blister packs 3 with tablets T has been presented above. Solid pharmaceutical products can also have different shapes and very different dimensions. In addition, the products do not have to be tablets Z pressed from powder. Sugar-coated pills, two-part capsules, and soft gelatin capsules, for example, are also known.

FIG. 11 shows top and side views of various types of solid pharmaceutical products. In the upper row, on the left, is a first form of tablet T, designated T₁. This tablet is round and has a cylindrical center section and convex top and bottom surfaces, where the radius of curvature is relatively large. Next on the right is a second form of tablet T, designated T₂. This is also round and has a cylindrical center section and convex top and bottom surfaces, but the radius of curvature is much smaller than that of the first example. Further toward the right is a third form of tablet T designated T₃. This form is round and cylindrical and has bevels on both sides. On the extreme right in the upper row is a fourth form of tablet T designated T₄. It looks the same from the side as the second form, but, as the top view shows, it is not round but oval.

In the bottom row on the left is a solid pharmaceutical product in the form of a two-part capsule S. Next to it on the right is the form of a sugar-coated pill D. These sugar-coated pills are another standard form of administration for pharmaceutical products. Although the round form is shown here, oval forms are also known. Further to the right is the form of a gelatin capsule G. These are often in the form of a rotational ellipsoid. Finally, at the extreme right, as yet another embodiment, is a form of a tablet T with an elongated form called an “oblong” O in professional circles. As an example, this tablet also has a groove R for breaking, which can be present in any of the various other forms of the tablet T.

Many pharmaceutical manufacturers are constantly creating new forms such as rhomboidal, triangular, pentagonal, and hexagonal shapes. Such special forms often lead to considerable problems with the job of introducing the tablets into the blister packs 3. Within the scope of the present invention, however, even solid pharmaceutical products with these special shapes can be packaged with ease.

It is obvious that the shapes of the rolls 11a, 11b must be designed to accommodate the specific type of solid pharmaceutical product. By way of example, several special advantageous designs for the rolls 11a, 11b are shown. The diagram is not exclusive. For additional types of products, some of which are shown in FIG. 11, different roll designs will be advantageous and can be used without abandoning the principle of the invention.

Without claiming to be exhaustive, FIGS. 12 and 12b show several special designs of the rolls 11a, 11b, which lie within the scope of the inventive principle. Each shows a plan view of parts of the two rolls 11a, 11b, representing sections removed from rolls analogous to those shown in FIG. 6. What is shown therefore is a part of the repeating sequence of individual sections 30, 31, 32 shown in FIGS. 5 and 6, extending along the length of the rolls 11a, 11b.

The example shown in FIG. 12a is characterized in that that noncylindrical section 31 does not have a conical form but rather represents a segment of a parabola. As a result, the gap 35 is not uniform in width along its entire extent. As also shown in FIG. 6, the rolls 11a, 11b are again mirror images of each other with respect to the sequence of sections 30, 31, 32. This form of the rolls 11a, 11b is suitable for solid pharmaceutical products with highly curved top and bottom surfaces.

The example shown in FIG. 12b is similar. The second cylindrical section 32 is lacking here, however. Between two sections 30, the noncylindrical section 31 is designed so that it has a hyperbolic form. Because the hyperbolic form is the same for both rolls 11a, 11b, the two rolls 11a, 11b are therefore identical. This roll form is especially suitable for elongated pharmaceutical products such as two-part capsules S (FIG. 11) and oblongs.

FIG. 13 shows a diagram of the placement of the rolls 11a, 11b above the isolating block 7 (FIG. 1). We see an isolating channel 8 and the associated entrance opening 41 with the upper blocking slide 40 and the lower blocking slide 42. The free distance between the upper blocking slide 40 and the lower blocking slide 42 is slightly larger than the height of a tablet T. It is also important, which is why this detail is shown here, that the position of the rolls 11a, 11b above the isolating block 7 is such that only a single tablet T can assume a vertical position in the space between the rolls 11a, 11b and above the upper blocking slide 40, i.e., a position suitable for introduction into the blister pack 3 (FIG. 1). The distance between the upper edge of the upper blocking slide 40 and the connecting line between the axes of the rolls 11a, 11b is therefore significant here. This distance should not be greater than the height of a tablet T. When this condition is satisfied, the result is that the other tablets T present above the connecting line will never, in practice, be able to stand vertically. Instead, because of the interaction of forces among them and the position of the noncylindrical sections 31 (FIG. 5) (not shown here), they will all be positioned at a pronounced angle. They then get in each other's way, so that none of the tablets T present in the upper area will be able to fall through to the upper blocking slide 40 when it is pulled back to allow the tablet already resting on the upper blocking slide 40 to drop down to the lower blocking slide 42. The next tablet T cannot be oriented in the manner described on the basis of FIGS. 7a-7c until the rolls 11a, 11b have rotated by a certain amount.

Because there are forms of such pharmaceutical products which can be oriented relatively easily, such as sugar-coated pills and the two-part capsules with their normally smooth surfaces, it can be advantageous for the rotational movement of the rolls 11a, 11b to proceed not continuously but rather discontinuously. It can be advantageous, for example, to stop the rotational movement before the upper blocking slide 40 is moved from the extended position shown in FIG. 13 back into the retracted position shown in FIG. 10.

It can also be advantageous for the rotational speed of the rolls 11a, 11b not to be the same but rather different. This can be achieved, for example, by providing separate drive motors, one for the first rolls 11a and one for the second rolls 11b. In the case of a drive with a belt 22 such as that shown in FIG. 3, however, it is possible for the rolls 11a and 11b to have different diameters at the ends with the annular grooves 21.

In an application of the inventive principle, any type of solid pharmaceutical product, namely, tablets T of different shapes and sizes, as well as two-part capsules S, sugar-coated pills D, gelatin capsules G, oblongs O, and other forms can be loaded into the blister packs 3 (FIG. 1) in a highly economical and reliable manner.

1-12. (canceled)

13. A device for introducing a plurality of solid pharmaceutical products selected from the group consisting of tablets, two-part capsules, sugar-coated pills, gelatin capsules, and oblongs along a path into a blister pack, the device comprising:
a distributing device having:
a roll frame;
at least one pair of first and seconds rolls rotatably mounted on the roll frame, the first and second rolls having respective non-cylindrical sections facing one another and spaced apart so as to define a gap configured to provide a passage for an individual pharmaceutical product;
a first means for rotating the first roll; and
a second means for rotating the second roll in a direction opposite a direction of rotation of the first roll.

14. The device of claim 13, further comprising:
a pan positioned and configured to receive the pharmaceutical products loaded as bulk material and to feed the pharmaceutical products to the first and second rolls;
an isolating block positioned to receive the individual pharmaceutical products from the gap of the distributing device; and
a plurality of isolating channels extending downstream from the isolating block and configured to sequentially convey each individual pharmaceutical product to an individual well of the blister pack.

15. The device of claim 13, wherein the noncylindrical sections of the first and second rolls are substantially conically shaped and are oriented so that the gap formed between the conically shaped noncylindrical sections is of substantially uniform width.

16. The device of claim 13, wherein the noncylindrical sections of the first and second rolls each are parabolically shaped.

17. The device of claim 13, wherein the noncylindrical sections of the first and second rolls each are hyperbolically shaped.

18. The device of claim 13, comprising a plurality of pairs of first and second rolls.

19. The device of claim 18, further comprising a cover frame having a web extending parallel to axes of the rolls, and configured and positioned to prevent the individual pharmaceutical products from passing between pairs of rolls and to permit the individual pharmaceutical products to pass between the first and second rolls of a pair of rolls.

20. The device of claim 19, wherein the web has a substantially triangular cross-section and is oriented so that slanted surfaces of the web guide the pharmaceutical products towards the gap between the first and second rolls of each roll pair.

21. The device of claim 13, wherein the first and second means for rotating comprise a motor driven device.

22. The device of claim 18, wherein the first and second means for rotating comprise a motor driven device operatively connected to the rolls by an endless belt.

23. The device of claim 13, wherein the first and second means are capable of rotating the rolls at different rotational speeds.

24. The device of claim 18, wherein the first and second means are capable of rotating the rolls at different rotational speeds.

25. The device of claim 18, wherein the first means is capable of rotating all of the first rolls and wherein the second means is capable of rotating all of the second rolls.

26. The device of claim 23, wherein the first and second means are operatively connected to a driven end of each of the first and second rolls, respectively, and the driven end of the first roll has a different diameter than the driven end of the second roll.

27. The device of claim 13, wherein the first and second means comprise a single driving means.

28. The device of claim 13, wherein the first and second means comprise two driving means.
